(19) United States
(12) Patent Application Publication
(10) Pub. No.: US 2005/0202829 A1
(43) Pub. Date: Sep. 15, 2005

(54) Satellite positioning system receiver utilizing time-aiding information from an independent source

(75) Inventors: Eko N. Onggosanusi, Allen, TX (US); Anand G. Dabak, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/026,436

(22) Filed: Dec. 30, 2004

Related U.S. Application Data
(60) Provisional application No. 60/549,437, filed on Mar. 1, 2004.

(51) Int. Cl. H04B 7/185

(52) U.S. Cl. 455/456.1; 455/12.1; 342/357.1

(57) ABSTRACT

An electronic device (10). The device has means (22₂) for receiving SPS information from an SPS system (40). The device also comprises means (22₃) for receiving broadcast timing information from a source (50) other than the SPS system. The device also comprises means for determining a location fix of the electronic device in response to the SPS information and the broadcast timing information.

### CROSS-REFERENCES TO RELATED APPLICATION

This application claims priority, under 35 U.S.C. Section 119, to provisional application U.S. Ser. No. 60/549,437, filed Mar. 1, 2004, entitled “Satellite Positioning System Receiver Utilizing Time-Aiding Information from an Independent Third-Party Source.”

### STATEMENT REGARDING FEDERALLY SPONSORED RESEARCH OR DEVELOPMENT

Not Applicable.

### BACKGROUND OF THE INVENTION

The present embodiments relate to electronic devices and are more particularly directed to an electronic device with a satellite positioning system receiving function, where the device performs positioning determinations in response, in part, to broadcasted time-aiding information from a source other than the satellite positioning system.

Electronic devices are extremely prevalent and beneficial in today's society and are constantly being improved due to consumer and user demand. One technological example has been the mobile or cellular telephone, which has seen great advances in the last many years. These devices have evolved beyond provision of voice services alone and are now accommodating greater amounts of data and are providing various additional features, more advanced operating systems, and additional programming. For example, so-called “smart phones” are envisioned as having a large impact on upcoming generations of cellular phones. As another example, various personal digital assistants (“PDAs”) are still succeeding in the marketplace and may do so for the foreseeable future. Further, the functionality of cellular phones and PDAs are now beginning to overlap with the possibility of a greater combination of the functionality of these devices into a single unit in the future.

With the advancement of the devices introduced above, various newer features are now being developed and implemented. One feature that is found in some past cellular phones and which is soon or already to be mandated in contemporary phones is the ability of the phone to report its geographical position of latitude, longitude, and altitude, as was recently driven by the E911 initiative. Per this initiative, such a feature may well serve beneficial when the phone's user places an emergency 911 call, whereby in response the phone then reports its geographic location so as to permit a better response to the call and the potential emergency that accompanies the call.

The ability of present cellular phones to report a geographic location of the phone has been provided by the phone using information from a satellite positioning system (“SPS”). Prior to its use in cellular phones, SPS has existed for decades and has been used in military and civil applications. The current SPS system includes the well-known US-owned global positioning satellite (“GPS”) system or NAVSTAR and the Russia-owned Global Navigation Satellite System (“GLONASS”). Additionally, the European Union has started its effort to support SPS with an initiative to position a constellation of satellites, called the Galileo system, for completion in the future. In any event, many cellular phones are now including an SPS functionality, whereby in general that functionality receives certain SPS information from satellites in order to determine a geographic location, which is sometimes referred to as either a location fix or a position fix. One type of information provided by the SPS to a cellular phone is timing information and, more particularly, is a highly precise indicator of absolute time, which is typically accurate to the tenths or hundredths of microseconds. The timing information is provided by highly accurate atomic clocks that are included with each of the SPS satellites. Such information is usable by an SPS receiver, in combination with other SPS information, to determine, among other things, the location fix of the SPS-enabled device. Other uses of this timing information are also currently being contemplated in the art.

In addition to receiving cellular information from satellites, certain SPS receivers now receive additional SPS information, for use in detecting a location fix, from other sources. As one example, so-called assisted GPS (“AGPS”) has more recently been developed in an effort to expedite the ability of a GPS receiver to make its first fix determination, that is, to acquire sufficient information so as to provide a location fix, after which subsequent location fixes may be ascertained relative to that first location fix. The time to make this first determination is sometimes referred to as TTFF, for “time to first fix.” In traditional GPS, TTFF may be on the order of minutes, which is workable in some instances but not superior in others. However, with AGPS, the TTFF has been reduced. In AGPS, high-performance reference receivers are added to a backbone network that is part of a cellular phone network, such as in the so-called mobile switching center of the network (which is also called by other names, depending on the cellular standard at issue). These reference receivers may operate full-time and are not constrained by the requirements that are often imposed on cell phone handsets, such as low power use and constrained device size and cost. Thus, the reference receivers may constantly receive information from the SPS, and that information is then collected in a system coordinator device. Accordingly, when a cellular phone places a 911 call to the cellular backbone, and with the requirement that the phone at that time needs to determine its location fix, rather than requiring the TTFF of the phone to be constrained by awaiting information from satellites, more recently there has been proposed that the cellular system provides information from the coordinator device to the particular 911-calling cellular phone. Thus, such information is received by the phone in a requested and bi-directional sense, by it calling the cellular backbone system and in response receiving the GPS information from that system; consequently, the information is received more quickly than such information may be obtained by the phone from one or more satellites. As a result, the phone is able to reduce its TTFF and report its location fix more quickly as compared to using conventional GPS.

While the preceding approach to providing SPS information to SPS-enabled devices has proven workable in certain implementations, the present inventors have observed that such an approach also may provide certain drawbacks. For example, reliance on a singular source of SPS information (e.g., the cellular system) to facilitate expedited location fix determinations lacks redundancy, should the information-providing system fail or delay. As another example, AGPS may be undesirable because it is only provided in a bi-directional sense and upon request to the user device in that the SPS timing information is only provided to a cellular device upon receipt of a 911 call. Still other examples will be ascertainable by one skilled in the art.

As a result of the preceding, there arises a need to address the drawbacks of the prior art as is achieved by the preferred embodiments described below.

### BRIEF SUMMARY OF THE INVENTION

In one preferred embodiment, there is an electronic device. The device comprises means for receiving SPS information from an SPS system. The device also comprises means for receiving broadcast timing information from a source other than the SPS system. The device also comprises means for determining a location fix of the electronic device in response to the SPS information and the broadcast timing information.

Other aspects are also disclosed and claimed.

### BRIEF DESCRIPTION OF THE SEVERAL VIEWS OF THE DRAWING

FIG. 1 illustrates a view of an example of a wireless telephone handset 10 into which a preferred embodiment is implemented.

FIG. 2 illustrates an electrical block diagram of various functional features of handset 10.

FIG. 3 illustrates an electrical block diagram of portions of the RF/analog circuitry of FIG. 2 and with emphasis on the signal path for signals received from three sources: (1) SPS satellites; (2) cellular network; and (3) an independent source providing SPS timing information.

### DETAILED DESCRIPTION OF THE INVENTION

The present invention is described below in connection with a preferred embodiment, namely as implemented into an electronic device such as a cellular telephone or a personal digital assistant (“PDA”), by ways of example. Still other electronic devices may implement the preferred embodiments, as may be evident in the wireless art such as satellite positioning system (“SPS”) enabled devices, which include as a subset global positioning system (“GPS”) devices and other devices introduced earlier. The present inventors believe that this invention is especially beneficial in such applications. However, the invention also may be implemented in, and provide significant benefit to, other electronic devices as well. Accordingly, it is to be understood that the following description is provided by way of example only and is not intended to limit the inventive scope.

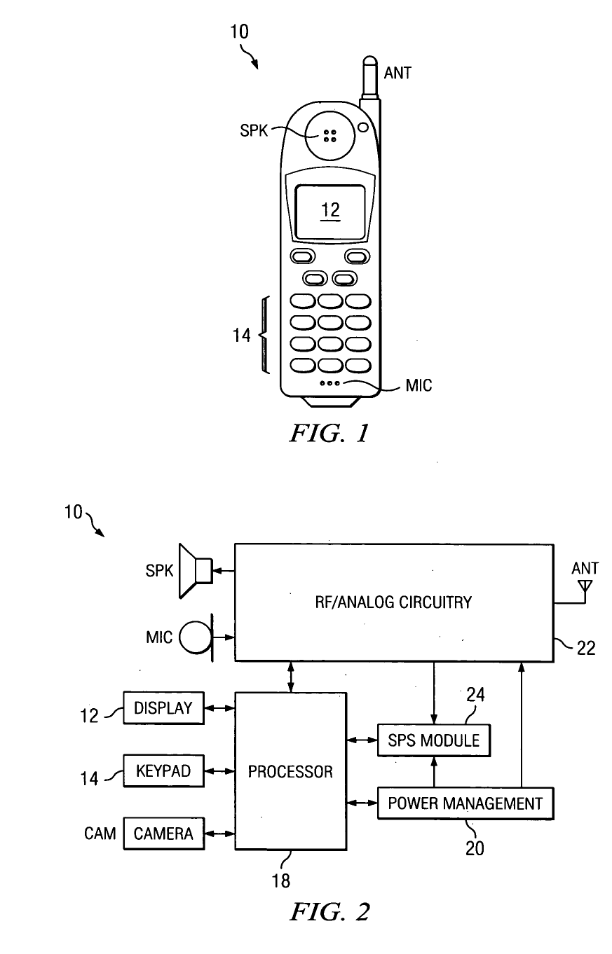

FIG. 1 illustrates an example of a wireless telephone handset 10 into which the preferred embodiment is implemented. In this example, handset 10 provides the conventional human interface features, including a microphone MIC, a speaker SPK, a visual display 12, and a keypad 14. Keypad 14 includes the usual keys for a wireless telephone handset, including numeric keys 0 through 9, the * and # keys, and other keys as in conventional wireless telephone handsets. According to the preferred embodiment of the invention, handset 10 is also operable in connection with SPS services to present on visual display 12 a geographic indication of the location of handset 10, or an indication in response to a determination of the geographic location; the location also may be transmitted by handset 10.

Referring now to FIG. 2, the construction of an exemplary electrical block diagram architecture for handset 10 according to a preferred embodiment is now described. Of course, the particular architecture of a wireless handset (or other device within the inventive scope) may vary from that illustrated in FIG. 2, and as such the architecture of FIG. 2 is presented only by way of example.

As shown in FIG. 2, the functionality of handset 10 is generally controlled by a processor 18. Processor 18 may take various forms, including an implementation where it is embodied as a single integrated circuit that includes both a core and a digital signal processor (“DSP”). High-performance processors that are suitable for use as such a core include the advanced RISC (“reduced instruction set computer”) machine (“ARM”) designed by a company known as ARM Limited. Further, examples of DSPs suitable for such use include the TMS320c5x family of digital signal processors available from Texas Instruments Incorporated. In any event, the functionality of processor 18 preferably includes programmable logic, such as a microprocessor or microcontroller, that controls the operation of handset 10 according to a computer program or sequence of executable operations stored in program memory. Preferably, the program memory is on-chip with processor 18, but alternatively it may be implemented in read-only memory (“ROM”) or other storage in a separate integrated circuit. The computational capability of processor 18 depends on the level of functionality required of handset 10, including the “generation” of wireless services for which handset 10 is to be capable. As known in the art, modern wireless telephone handsets can have a great deal of functionality in addition to communication of voice data, including the capability of internet web browsing data, email data handling, digital still and video photography, game playing, PDA functionality, and the like, as well as the SPS functionality detailed later. The DSP functionality of processor 18 performs the bulk of the digital signal processing for signals to be transmitted and signals received by handset 10. These functions include the necessary digital filtering, coding and decoding, digital modulation, and the like. Lastly, note that DSPs that are comparable in various respects are available in combined form with the above-discussed core on a single integrated circuit as a combined processor referred to by Texas Instruments Incorporated as an OMAP, although in present form they do not provide or support some of the SPS functions detailed later.

Continuing the example of FIG. 2, processor 18 is coupled to visual display 12 and keypad 14, each for performing well-known functionality and, where, as mentioned earlier, display 12 also may display SPS-determined location fixes. Additionally, processor 18 is coupled to a camera CAM, which may provide either still or video image functionality. Processor 18 also is coupled to a power management function 20. Power management function 20 distributes regulated power supply voltages to various circuitry within handset 10 and manages functions related to charging and maintenance of the battery (not shown) of handset 10, including standby and power-down modes to conserve battery power. Handset 10 also includes radio frequency (“RF”)/analog block 22, which is coupled to antenna ANT. RF/analog block 22 consumes power under control of power management function 20, and its RF aspect includes such functions as necessary to transmit and receive the RF signals at the specified frequencies to and from the cellular (or “wireless”) telephone communications network that communicates with handset 10. Thus, RF block 22, and its sub-blocks detailed later, are contemplated to include such functions as modulation circuitry and RF input and output drivers, and it may be constructed by one skilled in the art using various combinations of hardware and/or software as ascertainable by one skilled in the art so as to achieve the functionality described herein. By applying the necessary filtering, coding and decoding, and the like, analog circuitry in block 22 processes the signals to be transmitted (as received from microphone MIC) prior to modulation and the received signals (to be output over speaker SPK over for use in SPS determinations) after demodulation (hence in the baseband). Thus, typical functions included within the analog functionality of block 22 include an RF coder/decoder (“CODEC”), a voice CODEC, speaker amplifiers, and the like, as known in the art. As detailed later, RF/analog block 22 also includes sufficient functionality for receiving a signal from a source independent of either a cellular or SPS system.

Handset 10 also includes an SPS module 24, coupled to receive signals from RF/analog block 22 and to function in certain respects according to the art to process those signals in connection with processor 18. However, as detailed later, the SPS information received by module 24 from RF/analog block 22 is in part from a source that is independent of either the cellular or SPS system. In any event, with the information received from all sources, module 24 may process it consistent with SPS features that are now included in various cellular telephones and that process SPS signals from a receiver. Such a receiver receives unidirectional communications from the SPS system which, as known in the SPS art, is a constellation of a number of satellites that orbit the earth at a given angle relative to the equator. Each satellite transmits coded position and timing information in a low power signal and, in response, that information may be received by any SPS-enabled device, including handset 10. In the case of the latter, those signals are received by antenna ANT, converted by appropriate circuitry in RF/analog block 22, and processed by SPS module 24, either alone or in combination with the capabilities of processor 18. Moreover, this information may be supplemented by information received from the cellular system that is also communicating with handset 10; for example, as introduced earlier in the Background of the Invention section of this document, in an AGPS system, certain SPS information is transmitted to handset 10 directly from the cellular system in response to the handset placing a 911 call, and the processing of such information therefore is not delayed while waiting to receive it from the SPS system. Still further and according to the preferred embodiment, yet additional information may be received by SPS module 24 from a source independent of either the cellular or SPS system. Thus, in response to this information, module 24 preferably has a measurement engine and position engine from which a determination of the position or location fix of handset 10 is determined. This information may then be used in various contexts. For example, the location fix may be reported by handset 10 to a cellular system in the event that its user calls the emergency 911 service. In another example, the SPS information may be used in connection with a mapping (or other) program associated with the handset 10, so as to depict on display 12 the location of handset 10 (and its user) on a displayed map or to display other aspects that relate to the location fix of handset 10.

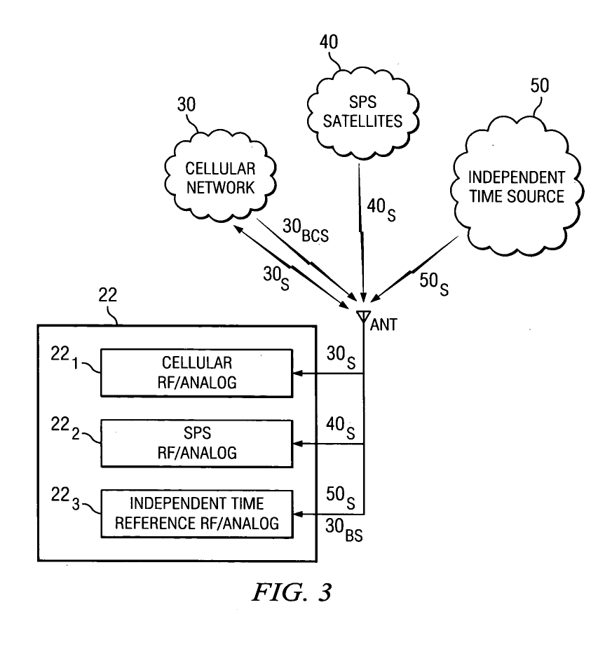

FIG. 3 illustrates a diagram of RF/analog block 22 of handset 10, from FIG. 2, in greater detail, along with the multiple sources that may communicate information to block 22. Particularly, RF/analog block 22 is shown to include three sub-blocks, namely, a cellular RF/analog block 22₁, an SPS RF/analog block 22₂, and an independent time reference RF/analog block 22₃. Each of these blocks communicates with a respective system, or portion thereof, also shown in FIG. 3. Particularly, FIG. 3 illustrates a cellular network system 30, an SPS satellite system 40, and an independent time source system 50. In general, each of these systems is known in the art, although the use of the signal from system 50 is per the preferred embodiment, as described below. Cellular network system 30 may be of any type of cellular system that is compatible with the protocol and coding schemes of handset 10, with current examples including time division multiple access (“TDMA”), code division multiple access (“CDMA”), and global system for mobile communications (“GSM”), as well as others that are now used or will be developed. SPS satellite system 40 is intended to represent the above-introduced collection of SPS satellites, such as the 24 GPS satellites as well as satellites in any of the other SPS systems. Lastly, independent time source system 50 is a system capable of transmitting timing information to handset 10 and, thus, to its RF/analog block 22 shown in FIG. 3, where that timing information facilitates the same SPS-determination functionality in handset 10 as is permitted currently when a mobile phone receives timing information from a cellular network in response to a 911 phone call, as introduced above; however, system 50 is referred to herein as an “independent time source” because the timing information it provides is independent from the bi-directional channel of a cellular system that is used to provide timing information to a mobile phone handset in response to a 911 call and it is also independent of SPS system 40. Moreover, in the preferred embodiment, the timing information provided by system 50 is broadcast information and, thus, is available to many different receivers, which contrasts with the prior art where timing information is provided by a cellular system to a single specific receiver in response to a request from that receiver. Lastly, as introduced earlier, in the preferred embodiment the timing information includes a highly precise indicator of absolute time, which is typically accurate to the tenths or hundredths of microseconds.

The operation of handset 10 in the context of FIG. 3 is now described. During normal cellular communications, such as the commencement of a call and the movement of handset 10 among different cells, RF/analog block 22, communicates bi-directionally with cellular network system 30 according to the prior art. Toward this end, block 22₂ includes sufficient circuitry, known in the art, for decoding and encoding the corresponding signals, as shown by the bi-directional signal 30_{S} between system 30 and block 22₁. Also during use of handset 10, SPS RF/analog block 22₂ may receive various SPS information from SPS satellite system 40, also according to the prior art and, thus, which may include pseudo-random codes, ephemeris data, almanac data, and timing information. Toward this end, block 22₂ includes sufficient circuitry, known in the art, for decoding and encoding the corresponding signals, as shown by the signal 40_{S} between system 40 and block 22₂. Thus, with the delay that accompanies non-assisted SPS or GPS determinations, handset 10 may determine SPS (e.g., GPS) location fixes per that data.

In addition to the preceding, according to the preferred embodiment, and unlike the prior art, during operation of handset 10 it also receives timing information from a source that is independent of signals 30_{S} and 40_{S}, that is, from independent time source 50. Thus, the timing information is from a source that is independent of a response to a call placed by handset 10, and also may be independent from cellular network system 30 or GPS satellite system 40. Further, in a preferred embodiment, such information from independent time source 50 is broadcast by another system; note that the term “broadcast” in this sense is intended to mean that the signal is repeatedly communicated (at either a set or varying period) to any compatible receiver rather than being directed to a specific receiver, where the latter occurs in response to a request or communication from such a specific receiver. With these considerations, in one preferred embodiment, independent time source 50 is provided by a digital video broadcast (“DVB”) tower. Thus, to the extent that DVB communications are now being developed in connection with cellular telephones, those communications are modified to include the subject timing information so that it is broadcast along with video information, as independent time source 50. In this case and toward this end, block 22₃ includes sufficient functionality, known in the art, for decoding a corresponding signal, as shown by the unidirectional broadcast signal 50_{S}, received by antenna ANT from system 50 and communicated to block 22₃. Thereafter, signals 50_{S} is decoded and provided to SPS module 24. As a result, this timing information may be used in the same manner as is prior art timing information provided in an AGPS system by a cellular system in response to a 911 call by handset 10, but of course in the present case of the preferred embodiment the timing information came from an independent source (e.g., DVB). Thus, there is no reliance on the cellular response for this timing information and there is redundancy should the cellular system be unavailable to provide this timing information at the appropriate time. In any event, with this timing information timely provided by independent time source 50, then coupled with the remaining SPS information from SPS satellite system 40, SGS module 24 may then make an expedited determination of a location fix, at a rate comparable to that of AGPS, but without having received AGPS timing information in response to a 911 call.

Another preferred embodiment contemplates an alternative to DVB for independent time source system 50. Specifically, in this embodiment, independent time source system 50 is provided by any of the radio towers in the NIST radio station system. The NIST broadcasts (i.e., regularly transmits to any NIST-capable receiver) time and frequency information 24 hours per day, 7 days per week to any capable receiver and the broadcast includes local atomic time. Indeed, many consumer-level atomic clocks are in fact radio receivers tuned to the NIST radio station and, thus, the time provided by such clocks is in fact either provided by, or at least updated from, the NIST radio station system. In any event, under this alternative preferred embodiment, the NIST system, as independent time source 50, broadcasts signals 50_{S} and that signal is received by antenna ANT and provided to block 22₃. Thus, block 22₃ again receives timing information from a source that is independent with respect to a receiver-specific cellular signal or an SPS signal, and that information is coupled with the remaining SPS information from SPS satellite system 40, so that SPS module 24 may then make an expedited determination of a location fix, at a rate comparable to that of AGPS, but without having received AGPS timing information in response to a 911 call.

Still another preferred embodiment contemplates an alternative to either DVB or the NIST system for timing information, but in this case that information also may be from cellular network system 30. More particularly, recall in the prior art that timing information is provided from the cellular system to a mobile phone in a bi-directional, requested, and receiver-specific manner, that is, in a bi-directional channel that is first queried by the mobile phone by a 911 call, with a response from that bi-directional channel that reports the timing information to the querying phone, and as shown as signal 30_{S} in FIG. 3. In contrast, in another preferred embodiment, cellular system 30 includes a dedicated broadcast channel that broadcasts the GPS timing information at repeated times and to all phones within the corresponding cell. For example, such a broadcast channel may be used in the 3GPP cellular networks like the mobile broadcast of multi-media services (“MBMS”). In FIG. 3, therefore, such a unidirectional broadcast channel signal 30_{BCS} is shown, in addition to the bi-directional signal 30_{S}, provided by cellular network 30. Thus, both signals are received by antenna ANT, but broadcast channel signal 30_{BCS} is communicated to block 22₃. In this manner, therefore, broadcast channel signal 30_{BCS} is available to handset 10 at any time and not in response to a particular call or request by handset 10. Thus, once more, block 22₃ is early informed of timing information from a source that is independent with respect to signals 30_{S} and 40_{S}. Further, in response to such information, and when coupled with the remaining SPS information from SPS satellite system 40, GPS module 24 may then make a determination of a location fix without having received AGPS timing information in response to a 911 call.

From the above it may be appreciated that the preferred embodiments provide a device that includes a satellite positioning system receiver, where the device performs positioning determinations (or “fixes”) in response, in part, to time-aiding information from a source other than either the SPS system or a bi-directional and query-responsive communication from a cellular system. The independently-provided timing information may be used by a device along with pseudorange information data provided from an SPS (e.g., GPS) system to determine the location of the device. Various preferred embodiments are provided for the source of the independently-provided timing information, where each has advantages that will be ascertainable by one skilled in the art. Indeed, note that use of the NIST time broadcast as described above may be particularly desirable since receivers to operate with that system are already available in the market and, thus, the design or certain aspects of such receivers may be incorporated into handset 10 so as to cooperate with the SPS functionality. Other advantages are also provided by the preferred embodiment. As one advantage, the timing information is provided in a redundant manner, that is, in addition to that timing information provided by the prior art, it is provided by an alternative and independent source. Thus, should one source of such information fail, the information is still provided by the other. Indeed, should the prior art source fail, then with the independent source and compatible decoding block 22₃ in handset 10, then handset 10 may still perform a portion, or after some additional time, full SPS determinations using additional information from SPS satellite system 40. As another advantage, with the implementation of the preferred embodiment, then the timing information need not be provided by a cellular system and, thus, such information may be removed from such a system, thereby freeing its resources for other uses. Thus, the preceding discussion and these examples should further demonstrate that while the present embodiments have been described in detail, various substitutions, modifications or alterations could be made to the descriptions set forth above without departing from the inventive scope which is defined by the following claims.

1. An electronic device, comprising:
means for receiving SPS information from an SPS system;
means for receiving broadcast timing information from a source other than the SPS system; and
means for determining a location fix of the electronic device in response to the SPS information and the broadcast timing information.

2. The device of claim 1 wherein the means for receiving broadcast timing information comprises means for decoding broadcast timing information from an NIST system.

3. The device of claim 1 wherein the means for receiving broadcast timing information comprises means for decoding broadcast timing information from a digital video broadcast system.

4. The device of claim 1 wherein the means for receiving broadcast timing information comprises means for decoding broadcast timing information from a broadcast cellular channel.

5. The device of claim 4:
wherein the broadcast cellular channel is transmitted from a cellular system; and
wherein the device further comprises circuitry for communicating cellular data bi-directionally between the device and the cellular system.

6. The device of claim 5 wherein the cellular data is selected from a set consisting of voice data, Internet data, email data, and image data.

7. The device of claim 1 and further comprising circuitry for communicating cellular data bi-directionally between the device and a cellular system.

8. The device of claim 7 wherein the source is independent of the cellular system.

9. The device of claim 1 and further comprising a core and a digital signal processor.

10. The device of claim 1 wherein the means for receiving SPS information, means for receiving broadcast timing information, and the means for determining are part of an electronic device selected from a set consisting of a telephone and a personal digital assistant.

11. The device of claim 1 and further comprising means for displaying the location fix to a user.

12. The device of claim 1 wherein the means for receiving broadcast timing information is selected from a set consisting of means for decoding broadcast timing information from an NIST system, means for decoding broadcast timing information from a digital video broadcast system, and means for decoding broadcast timing information from a broadcast cellular channel.

13. The device of claim 12 wherein the broadcast timing information comprises an indicator of absolute time.

14. The device of claim 12 wherein the means for receiving SPS information, the means for receiving broadcast timing information, and the means for determining are all part of an electronic device selected from a set consisting of a telephone and a personal digital assistant.

15. The device of claim 14 and further comprising means for displaying the location fix to a user.

16. The device of claim 15 wherein the broadcast timing information comprises an indicator of absolute time.

17. An electronic device, comprising:
means for receiving SPS information from an SPS system;
means for communicating cellular data with a cellular network;
means for receiving timing information from a source other than the SPS system and the cellular network; and
means for determining a location fix of the electronic device at least in part in response to the timing information.

18. The device of claim 17 wherein the means for receiving timing information comprises means for decoding timing information from an NIST system.

19. The device of claim 17 wherein the means for receiving timing information comprises means for decoding timing information from a digital video broadcast system.

20. The device of claim 17 wherein the cellular data is selected from a set consisting of voice data, Internet data, email data, and image data.

21. The device of claim 17 and further comprising a core and a digital signal processor.

22. The device of claim 17 wherein the means for receiving SPS information, the means for communicating cellular data with a cellular network, the means for receiving timing information, and the means for determining a location fix, are all part of an electronic device selected from a set consisting of a telephone and a personal digital assistant.

23. The device of claim 22 wherein the broadcast timing information comprises an indicator of absolute time.

24. The device of claim 17 wherein the broadcast timing information comprises an indicator of absolute time.

25. A method of operating an electronic device, comprising:
receiving SPS information from an SPS system;
receiving broadcast timing information from a source other than the SPS system; and
determining a location fix of the electronic device in response to the SPS information and the broadcast timing information.

26. The method of claim 25 wherein the step of receiving broadcast timing information is selected from a set consisting of receiving broadcast timing information from an NIST system, receiving broadcast timing information from a digital video broadcast system, and receiving broadcast timing information from a broadcast cellular channel.

27. The method of claim 26 wherein the broadcast timing information comprises an indicator of absolute time.

28. The method of claim 25 wherein the step of receiving broadcast timing information comprises receiving broadcast timing information from a broadcast cellular channel.

29. The method of claim 28:
wherein the broadcast cellular channel is transmitted from a cellular system; and
further comprises communicating cellular data bi-directionally between the device and the cellular system.

30. The method of claim 29 wherein the cellular data is selected from a set consisting of voice data, Internet data, email data, and image data.

31. The method of claim 30 wherein the broadcast timing information comprises an indicator of absolute time.

32. The method of claim 25 and further comprising communicating cellular data bi-directionally between the device and a cellular system.

33. The method of claim 32 wherein the source is independent of the cellular system.

34. The method of claim 33 wherein the broadcast timing information comprises an indicator of absolute time.

35. The method of claim 25 and further comprising displaying the location fix to a user.

36. A method of operating an electronic device, comprising:
receiving SPS information from an SPS system;
communicating cellular data with a cellular network;
receiving timing information from a source other than the SPS system and the cellular network; and
determining a location fix of the electronic device at least in part in response to the timing information.

37. The method of claim 36 wherein the step of receiving broadcast timing information is selected from a set consisting of receiving broadcast timing information from an NIST system and receiving broadcast timing information from a digital video broadcast system.

38. The method of claim 36 wherein the broadcast timing information comprises an indicator of absolute time.
